(19) United States
(12) Patent Application Publication
(10) Pub. No.: US 2008/0253605 A1
(43) Pub. Date: Oct. 16, 2008

(54) MULTIPLE INPUT ACOUSTIC COUPLER

(75) Inventor: Richard C. Smith, Costa Mesa, CA (US)

Correspondence Address: MACPHERSON KWOK CHEN & HEID LLP, 2033 GATEWAY PLACE, SUITE 400, SAN JOSE, CA, 95110, US

(73) Assignee: SureFire, LLC

(21) Appl. No.: 11/870,165

(22) Filed: Oct. 10, 2007

Related U.S. Application Data
(63) Continuation-in-part of application No. 11/403,646, filed on Apr. 13, 2006.
Application No. 11/403,646 is a continuation-in-part of application No. 10/769,158, filed on Jan. 29, 2004, now Pat. No. 7,394,910.
Application No. 10/769,158 is a continuation-in-part of application No. 11/247,105, filed on Oct. 11, 2005.

(51) Int. Cl. H04R 25/00

(52) U.S. Cl. 381/381

(57) ABSTRACT

A method and system for enhancing communications, such as those involving a two-way radio, are disclosed. More particularly, an acoustic coupler can comprise an output port configured to attach to an earpiece and a plurality of input ports in acoustic communication with the output port. Each of the input ports can facilitate communication from a different audio device to the user. For example, one input port can receive voice communications from a two-way radio, another input port can receive voice communications from a cellular telephone, and another input port can receive music from a music player. In this manner, a user can listen to multiple audio devices without reconfiguring an earpiece that is used for such listening.

### RELATED APPLICATION

This patent application is a continuation-in-part (CIP) patent application of U.S. patent application Ser. No. 11/403,646, filed on Apr. 13, 2006, and entitled SWIVEL ELBOW (docket no. M-16270 US). U.S. patent application Ser. No. 11/403,646 is a CIP of U.S. patent application Ser. No. 10/769,158 filed on Jan. 29, 2004, and is also a CIP of U.S. patent application Ser. No. 11/247,105 filed on Oct. 11, 2005. The entire contents of each of these patent applications is hereby expressly incorporated by reference.

### TECHNICAL FIELD

The present invention relates generally to acoustics. The present invention relates more particularly to a coupler for attaching acoustic tubing from multiple audio sources to an earpiece so as to facilitate listening to multiple audio devices, such as a two-way radio, a cellular-telephone, and/or a music player (such as an MP3® player or an iPod®).

### BACKGROUND

Elbows for use with earpieces are well known. Such elbows are used with police and military two-way radios to attach acoustic tubing to the earpiece. The elbow provides acoustic communication from the acoustic tubing to the earpiece via a bore formed contiguously through the acoustic tubing, elbow, and the earpiece.

The elbow forms a right angle turn so that the acoustic tubing can extend along the wearer's head, instead of away therefrom. Without the elbow, the acoustic tubing would extend generally perpendicularly away from a wearer's head. This may be awkward and could result in the acoustic tubing inadvertently getting caught on something and the earpiece thus being undesirably pulled out of the wearer's ear.

Contemporary elbows have proven generally useful for their intended purpose. However, they possess deficiencies that detract from their overall utility and desirability

For example, contemporary elbows only facilitate attachment of an earpiece to one audio device, e.g., a two-way radio. Thus, according to contemporary methodology, an earpiece can only be used to listen to a single audio device. If it is desirable to listen to more than one device, then a device (such as a two-way radio) must be disconnected from the earpiece and another device must be attached to the earpiece. Thus, the user must reconfigure the earpiece for use with each audio device singularly (only one audio device can be used at a time).

The disconnection of one audio device and the attachment of another audio device is time consuming and inconvenient. The disconnection of one audio device and the attachment of another audio device may not even be an option under some circumstance, such as during covert operations or in battlefield situations wherein the earpiece cannot be disconnected from a two-way radio without jeopardizing the safety of the user.

Because of the growing popularity of audio devices such as cellular telephones and music players (MP3® players and iPods®, for example), it is desirable to facilitate the attachment of an earpiece to multiple audio devices.

### BRIEF SUMMARY

A method and system for enhancing communications, such as those involving a cellular telephone or a two-way radio, are disclosed. More particularly, according to an example of an embodiment an acoustic coupler can comprise an output port configured to attach to an earpiece and a plurality of input ports in acoustic communication with the output port. Each of the plurality of input ports can facilitate communication from a different audio device to the user. For example, one input port can receive voice communications from a two-way radio, another input port can receive voice communications from a cellular telephone, and another input port can receive music from a music player. Thus, an acoustic coupler can comprise an output port and means for facilitating acoustic communication from a plurality of audio devices to the output port.

According to an example of an embodiment, an earpiece assembly can comprise an earpiece configured to be received within the conchae of an ear and an acoustic coupler attached to the earpiece. Alternatively, the earpiece can be an earpiece other than one that is configured to be received within the conchae.

According to an example of an embodiment, a cable assembly can comprise at least two electrical cables configured to communicate electrical signals representative of sound, at least two speakers wherein each speaker is in electrical communication with a dedicated one of the electrical cables, at least two acoustic tubes wherein each acoustic tube is in acoustic communication with a dedicated one of the speakers, and an acoustic coupler is in acoustic communication with the acoustic tubes. The acoustic coupler can provide sound to an earpiece.

According to an example of an embodiment, a method for assembling an earpiece assembly can comprise attaching a multiple input acoustic coupler to an earpiece. The earpiece assembly can then be used to facilitate listening to multiple audio devices without the need to reconfigured the earpiece. Thus, it is not necessary to remove one audio device from the earpiece in order to attach another audio device thereto.

According to an example of an embodiment, a method for providing sound from two or more audio devices to an earpiece can comprise acoustically mixing the sound in a fitting that is attached to the earpiece. For example, the sound from two audio devices can be mixed within an acoustic coupler that attaches acoustic tubing to the earpiece.

Multiple audio devices, such as any desired combination of two-way radios, cellular telephones, and music players (such as MP3® players or iPods®), can be attached to an earpiece. In this manner, an earpiece can be used to listen to a plurality of such audio devices. A user can listen to multiple audio devices without reconfiguring an earpiece that is used for such listening. The user can listen to audio devices simultaneously, if desired.

This invention will be more fully understood in conjunction with the following detailed description taken together with the following drawings.

### BRIEF DESCRIPTION OF THE DRAWINGS

FIG. 1 is a semi-schematic perspective view of a single barb multiple input acoustic coupler according to an example of an embodiment;

FIG. 2 is a semi-schematic perspective view of the multiple input acoustic coupler of FIG. 1, showing the bores thereof in dashed lines;

FIG. 3 is a semi-schematic perspective view of a triple barb multiple input acoustic coupler according to an example of an embodiment;

FIG. 4 is a semi-schematic perspective view of an earpiece with a flanged extension having the multiple input acoustic coupler of FIG. 1 attached thereto;

FIG. 5 is a semi-schematic perspective view of the earpiece of FIG. 4, showing the flanged insert and multiple input acoustic coupler exploded therefrom;

FIG. 6 is a semi-schematic side view of an upper portion of a cable assembly that is attached to an earpiece using a multiple input acoustic coupler according to an example of an embodiment;

FIG. 7 is a semi-schematic side view of an example of a lower portion of a cable assembly that is attachable to the upper portion of the cable assembly of FIG. 6;

FIG. 8 is a semi-schematic side view of an earpiece disposed within the conchae of a user's ear and having a multiple input acoustic coupler attached thereto;

FIG. 9 is a semi-schematic perspective side view of a body and a single barbed tubular portion according to an example of an embodiment;

FIG. 10 is a semi-schematic perspective view of the body and tubular portion of FIG. 9, with two more barbed tubular exploded from the body; and

FIG. 11 is a semi-schematic perspective view of the body and barbed tubular portions of FIG. 10 wherein all of the barbed tubular portions are attached to the body.

Embodiments of the present invention and their advantages are best understood by referring to the detailed description that follows. It should be appreciated that like reference numerals are used to identify like elements illustrated in one or more of the figures.

### DETAILED DESCRIPTION

A method and system for interconnecting acoustic devices, such as those of a communications system, are disclosed. The method and system can facilitate the attachment of multiple acoustic devices to a single earpiece so as to facilitate easy and convenient listening to the acoustic devices. A plurality of acoustic devices can be heard simultaneously, if desired.

According to an embodiment, a multiple input acoustic coupler can comprise an output port configured to attach to an earpiece and a plurality of input ports in acoustic communication with the output port. Each port (input and/or output) can comprise an elongated tubular portion. Each port can optionally further comprise one or more barbs for securely attaching the multiple input acoustic coupler to desired items. For example, the output port can be attached to an earpiece and each of the input ports can be attached to an audio device. The input ports can be attached to the audio devices via acoustic tubing.

The tubular portions of the multiple input acoustic coupler can be generally orthogonal with respect to one another. The tubular portions of the multiple input acoustic coupler can be non-orthogonal with respect to one another. The tubular portions of the multiple input acoustic coupler can be at any desired angle or combination of angles with respect to one another. Thus, the input ports can be generally orthogonal with respect to the output port. Also, the output port and the input ports can be generally orthogonal with respect to one another.

The input ports can be configured so as to accommodate the anatomical configuration of the ear. For example, the multiple input acoustic coupler can comprise two input ports and one output port wherein the angle between the two input ports is an angle that allows the two input ports to be comfortably disposed upon the two sides of the tragus. The angle between each of the input ports and the output port can similarly be an angle that allows the two input ports to be comfortably disposed upon the two sides of the tragus. The angle between the two input ports can be greater than 90 degrees and the angle between each input port and the output port can be greater than 90 degrees. By accommodating the anatomical configuration of the ear, the multiple input acoustic coupler can be made more ergonomic.

The input ports can be approximately the same size with respect to one another. Alternatively, input ports can be different sizes with respect to one another.

Similarly, the output port and the input ports can be approximately the same size with respect to one another. Alternatively, the output port and the input ports can be different sizes with respect to one another. All of the ports (input and/or output) can be different sizes with respect to one another.

All of the ports can have approximately the same diameter or the ports can have different diameters. All of the ports can have approximately the same length or the ports can have different lengths. Moreover, the ports can be of any desired combination of diameters, lengths, angles with respect to one another, and configurations (such as regarding number of barbs).

The multiple input acoustic coupler can comprise two ports, three ports, four ports, or more ports. The multiple input acoustic coupler can comprise up to five generally orthogonal input ports. The multiple input acoustic coupler can comprise any desired number of non-orthogonal input ports. The multiple input acoustic coupler will typically comprise one output port. The multiple input acoustic coupler can comprise any desire number of input ports.

The input port and the output ports can be formed of plastic. The input ports and the output port can be integrally formed, such as by molding all of the ports of the multiple input acoustic coupler as a single device. Ports can be formed of different materials with respect to one another.

The multiple input acoustic coupler can comprise a plurality of ports that are attachable to one another. In this manner, the ports can be custom configured for a particular application and/or user. For example, the angle between two adjacent input ports, as well as the diameter and length of the input ports, can be tailored so as to better accommodate the user's ear anatomy, particularly that of the conchae and the tragus.

The multiple input acoustic coupler can be formed of a material that allows the ports to be bent. Thus, the angle of the ports with respect to one another, as well as the shape of the ports, can be varied. The input ports can be bent so as to better accommodate the anatomical structures of the ear. For example, the input ports can be bent so as to provide better routing around the tragus.

An embodiment can comprise an earpiece assembly comprising an earpiece configured to be received within the conchae of an ear and a multiple input acoustic coupler attached to the earpiece. The acoustic coupler can comprise an output port configured to attach to an earpiece and a plurality of input ports in acoustic communication with the output port. Each of the inputs ports can be attached to a different audio device so as to facilitate listening thereto.

An embodiment can comprise a cable assembly comprising at least two electrical cables configured to communicate electrical signals representative of sound, at least two speakers wherein each speaker is in electrical communication with a dedicated one of the electrical cables, at least two acoustic tubes wherein each acoustic tube is in acoustic communication with a dedicated one of the speakers, and an acoustic coupler in acoustic communication with the acoustic tubes. The acoustic coupler can comprise an output port configured to attach to an earpiece and a plurality of input ports in acoustic communication with the output port. An earpiece can be in acoustic communication with multiple input acoustic couplers.

An embodiment can comprise a method for assembling an earpiece assembly wherein the method comprises attaching an acoustic coupler to an earpiece. The acoustic coupler can comprise an output port that is configured to attach to the earpiece and a plurality of input ports that are in acoustic communication with the output port. The acoustic coupler can be attached to the earpiece by any desired method. For example, the acoustic coupler can be friction fit, attached via barbs or detents, adhesively bonded, and/or ultrasonically welded to the earpiece.

Optionally, a filter can be disposed within or proximate one of the ports. For example, a Hochs filter can be disposed within the output port to facilitate filtering of all of the audio provided to the earpiece. Similarly, a Hochs filter can be disposed within one or more of the input ports to facilitate filtering of the audio provided via those particular input ports.

One or more of input ports can rotate or swivel with respect to the input port as disclosed in U.S. patent application Ser. No. 11/403,646, filed on Apr. 13, 2006, and entitled SWIVEL ELBOW, the entire contents of which are hereby incorporated by reference.

The output port and the input ports can have any desired number of barbs formed thereon. For example, the output port and the input ports can have zero, one, two, three, four, or more barbs formed thereon. Each port (input or output) can have any desired number of barbs formed thereon. Thus, each port does not have to have the same number of ports formed thereon. For example, the output port can have zero barbs formed thereon, one input port can have one barb formed thereon, another input port can have two barbs formed thereon, and another input port can have three barbs formed thereon. Thus, the multiple input acoustic coupler can have any desired combination of barbs formed upon the ports thereof.

Indeed, the multiple input acoustic coupler can have any combination of port diameters, lengths, number of barbs and any other attributes. For example, all of the ports can have different diameters, lengths, and number of barbs.

According to an embodiment, a method for providing sound from two audio devices to an earpiece can comprise acoustically mixing the sound in a fitting that is attached to the earpiece. The fitting can have any desired physical configuration.

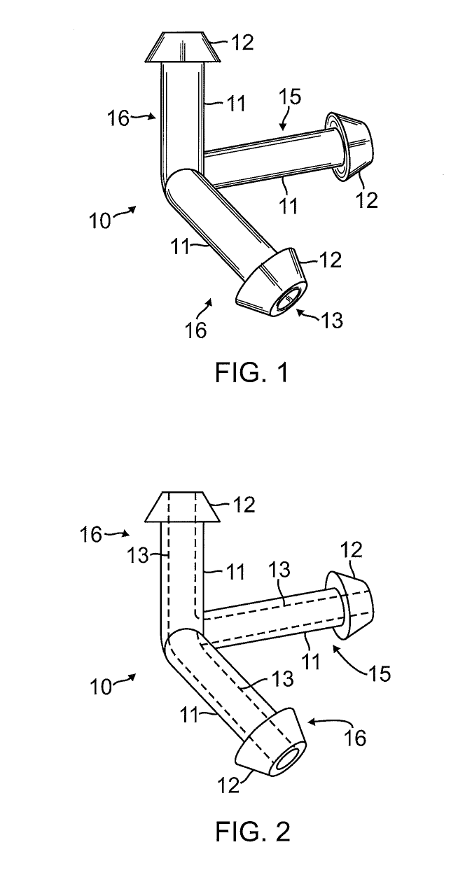

Referring now to FIGS. 1 and 2, according to an example of an embodiment, a multiple input acoustic coupler comprises three ports. Each port can comprise a tubular portion 11 and a barb 12. The ports can be generally orthogonal to one another. Alternatively, the ports can be at any other desired angle with respect to one another.

One of the ports can be an output port 15. The other two ports can be input ports 16. The output port 15 and the input ports 16 can be substantially identical to one another, thus making the designations of output and input somewhat arbitrary (at least when the acoustic coupler is not attached to anything). Alternatively, the output port 15 and/or the input ports 16 can be different from one another. For example, the ports can vary in length, inner diameter, outer diameter, number of barbs, material, configuration of bore (presence of obstructions or filters) or in any other aspect thereof.

The tubular portion 11 of each port can comprise a bore 13 formed therethrough. The bore 13 can be formed entirely through the tubular portion 11 or can be formed partially therethrough. The bore 13 can be formed entirely though the tubular portion so as allow sound to travel therethrough substantially unmodified. The bore 13 can be formed partially though the tubular portion so as to modify sound passing therethrough. For example, the port can contain obstructions, partitions, filters, and/or portions of reduced diameter so as to modify the spectral content and/or intensity of sound passing therethrough.

The bores 13 can all be interconnected such that sound can be communicated therethrough. Thus, sound from any input port 16 can be transmitted to the output port 15.

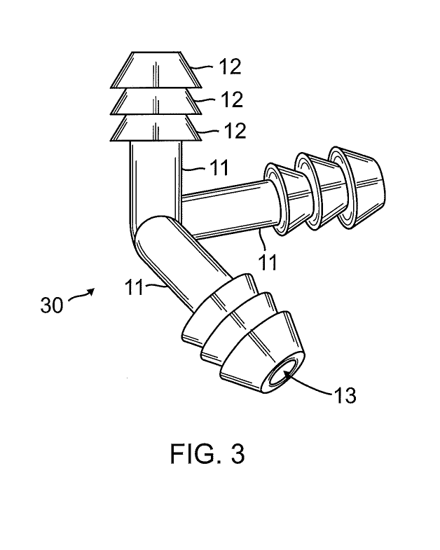

Referring now to FIG. 3, according to an example of an embodiment, a multiple input acoustic coupler 30 can have three barbs 12 on each port thereof. Generally, the more barbs that a port has, the more securely that port can be attached to another item such as an earpiece or acoustic tubing.

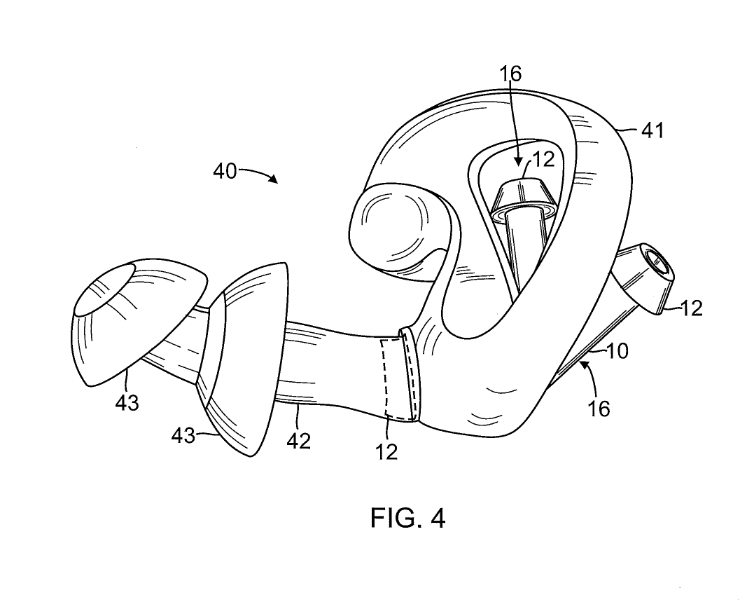

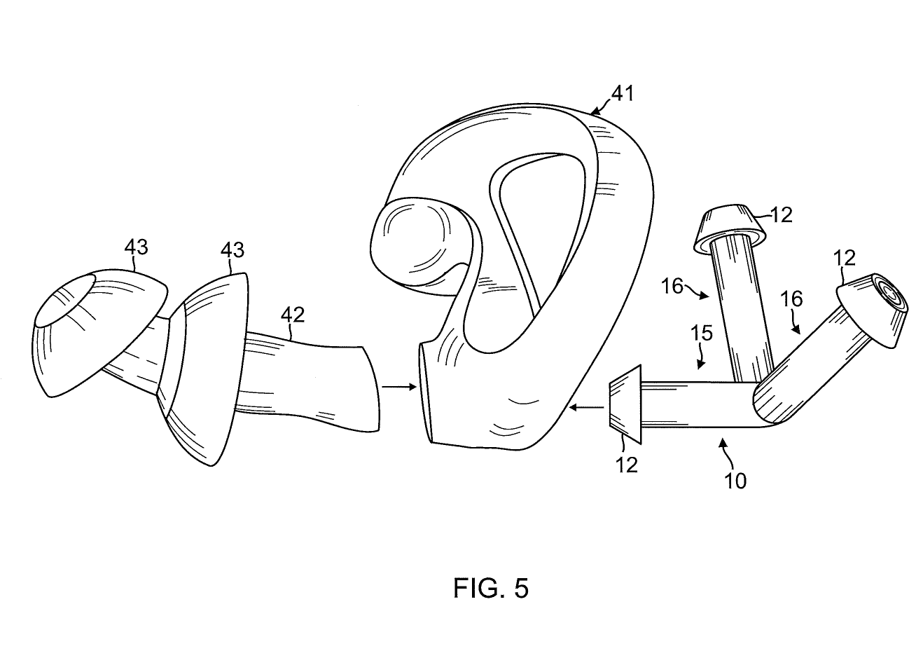

Referring now to FIGS. 4 and 5, an earpiece assembly 40 can comprise a multiple input acoustic coupler 10 that is attached to an earpiece 41. The earpiece 41 can be configured to be disposed within the conchae of a user's ear.

Optionally, an insert such as flanged insert 42 can extend from the earpiece 41. The insert can be configured to be received within a user's ear canal. One or more flanges 43 can be formed upon insert 42.

Examples of earpieces and inserts are disclosed in U.S. patent application Ser. No. 11/247,105, filed on Oct. 11, 2005, and entitled EARPIECE WITH FLANGED EXENSION, the entire contents of which are hereby expressly incorporated by reference.

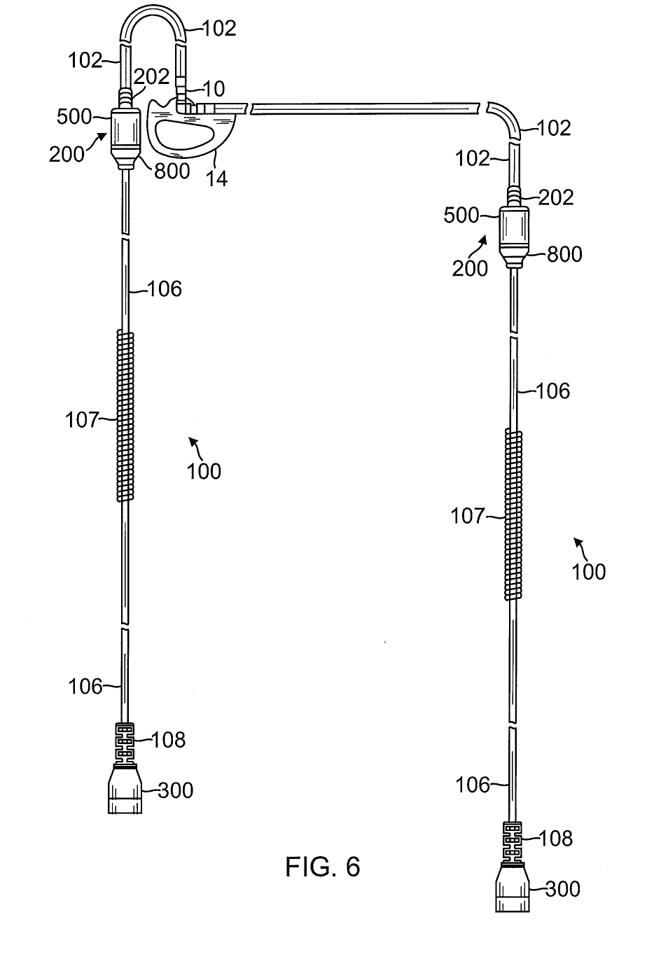

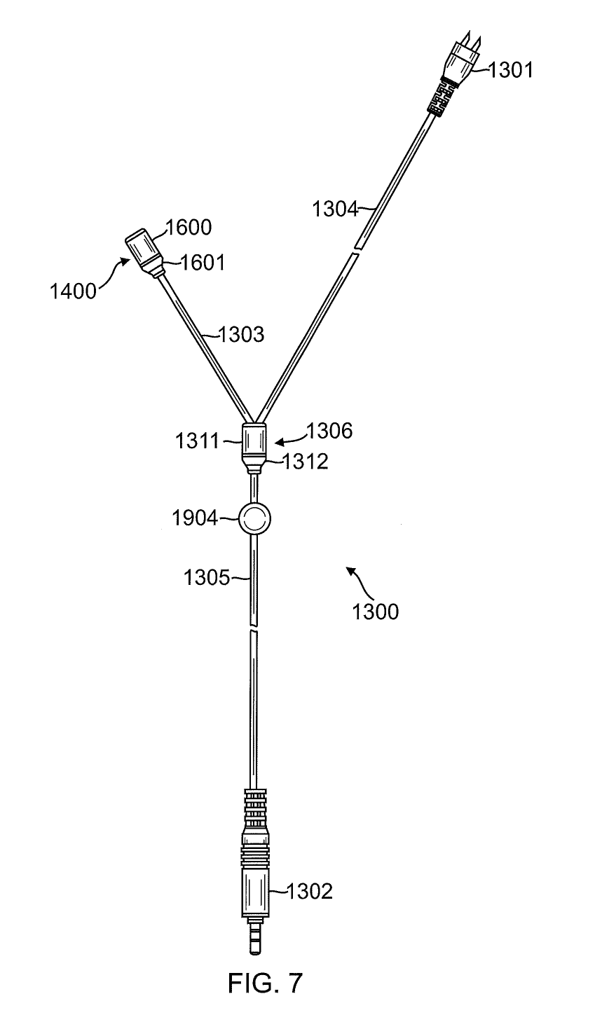

Referring now to FIGS. 6 and 7, one or more embodiments of the multiple input acoustic coupler can be used to partially define a cable assembly for use with multiple audio devices. For example, the cable assembly can be used with a two-way radio and a cellular telephone. As a further example, the cable assembly can be used with a cellular telephone and a music player (such as an MP3® player or an iPod®). The cable assembly can be used with any desired number and/or combination of audio devices.

Thus, the multiple inlet acoustic coupler allows two or more cables to provide sound to the user's ear. The sound can be provided from each cable (and thus from each audio device) simultaneously. Each cable can be attached to a different audio device and thus can provide different sound to the user's ear. Connectors 300 of each cable can attach to an audio device. Alternatively, one or more of the connectors 300 can attach to another cable, such as another cable that has a microphone like the cable of FIG. 7.

A cable assembly can comprise a plurality of upper portions 100, as shown in FIG. 6 (wherein two upper portions 100 are shown). The cable assembly can optionally comprise one or more lower portions 1300, as shown in FIG. 7. One or both upper portions 100 can be connected to a lower portion 1300, to form a radio cable assembly that facilitates both reception and transmission. Alternatively, one or more upper portions 100 can attach to an audio device within using a lower portion as discussed above. Thus, an upper portion 100 can connect directly to an audio device. For example, when the microphone 1400 of the lower portion 1300 is not required, then the upper cable portion(s) 100 can be configured so as to connect directly to one or more audio devices.

The upper portions 100 can comprise speakers that provide sound to the user's ear via the multiple input acoustic coupler 14. The lower portion can comprise a microphone 1400, such as for use with a two-way radio and/or a cellular telephone. The upper portion 100 and the lower portion 1300 can be integrated so as to provide a single cable instead of two separate cable portions.

With particular reference to FIG. 6, two upper cable portions 100 can be attached to an earpiece that is configured to fit within the conchae of a user's ear so as to transmit sound (such as incoming radio transmissions) to the user's eardrum. Examples of suitable earpieces are disclosed in U.S. Patent Application Ser. No. 11/411,314, filed on Apr. 26, 2006, and entitled EARPIECE WITH EXTENSION, the entire contents of which are hereby expressly incorporated by reference.

Earpiece 101 can be attached to acoustic tubing 102, such as via multiple input acoustic coupler 10. Acoustic tubing 102 can be curved so as to facilitate easy routing thereof behind the ear. Speaker 200 can be worn directly behind the ear, behind the ear at the neck, in front of the ear, in the ear, or at any other desired location. Either acoustic tubing from speaker 200 or electrical cable to speaker 200 can pass by or behind the ear.

Acoustic tubing 102 can be attached to speaker 200, such as via a barbed fitting 202. Speaker 200 can comprise upper 500 and lower 800 housings. A multi-conductor electrical cable 106 can extend from speaker 200 to a connector, such as female connector 300 that electrically connects upper portion 100 of the radio cable assembly 2000 to lower portion 1300 (FIG. 7). For example, electrical cable 106 can comprise two conductors that facilitate operation of speaker 200. Strain relief 108 can be provided for electrical cable 106 at connector 300. Electrical cable 106 can comprise coils 107 that allow it to stretch as necessary to fit a particular individual.

Electrical cable 106 can provide electrical signals to speaker 800. Speaker 800 can convert such electrical signals into acoustic signals representative thereof (and generally representative of speech received from a portable two-way radio).

With particular reference to FIG. 7, lower cable assembly 1300 can comprise a microphone 1400 that is configured to attach to the user's clothing, such as proximate the user's mouth. For example, microphone 1400 can clip to the user's lapel.

A connector, such as male connector 1301, can facilitate electrical connection of lower cable assembly 1300 to connector 300 of upper cable assembly 100. A connector, such as stereo phono plug 1302, can be used to connect lower cable assembly 1300 (and consequently complete radio cable assembly 2000, to portable two-way radio 2001). Phono plug 1302 can plug directly into portable two-way radio 2001 or can plug into a side mount 2002 of radio 2001.

Cable 1303 facilitates electrical connection between microphone 1400 and connector 1302. Similarly, cable 1304 facilitates electrical connection between upper portion of cable assembly 100 and connector 1302. Cable 1303 and cable 1304 can join at Y-joint 1306 to form single cable 1305.

Examples of cable assemblies are disclosed in U.S. patent application Ser. No. 11/696,987, filed on Apr. 5, 2007, and entitled CELLULAR TELEPHONE CABLE ASSEMBLY, the entire contents of which are hereby expressly incorporated by reference.

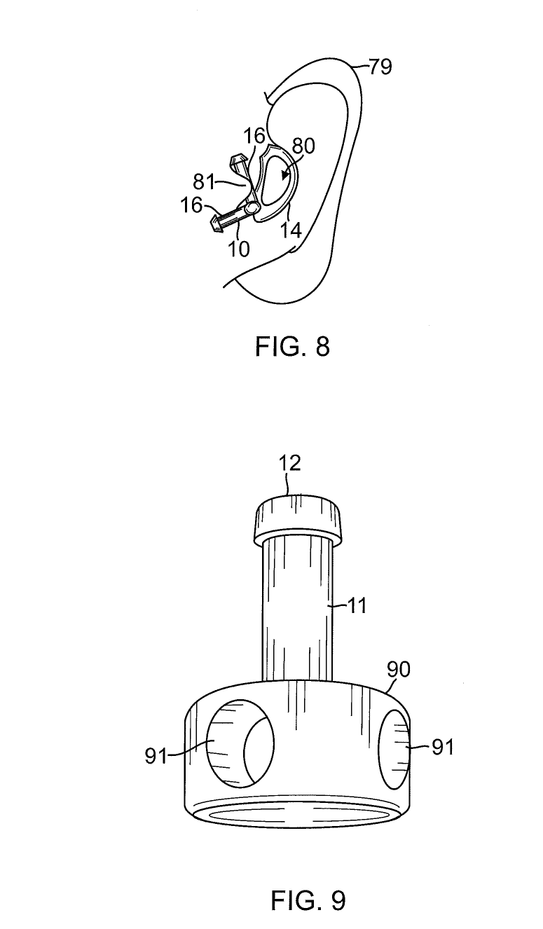

Referring now to FIG. 8, an earpiece assembly comprising an earpiece 14 and a multiple input acoustic coupler 10 is shown as it is being worn by a user. The earpiece 14 is disposed within the conchae 80 of the user's ear 79. The two input ports 16 are routed around the tragus 81. One input port 16 is routed above the tragus 81 and one input port 16 is routed below the tragus 81. In this manner, the input ports 16 of the multiple input acoustic coupler 10 are positioned such that they comfortably facilitate the attachment of two acoustic devices to the earpiece 14.

The input ports 16 can be bendable as discussed above. In this manner, the input ports 16 can be better routed around the tragus 81. The input ports 16 can be pre-bent so as to be better routed around the tragus 81.

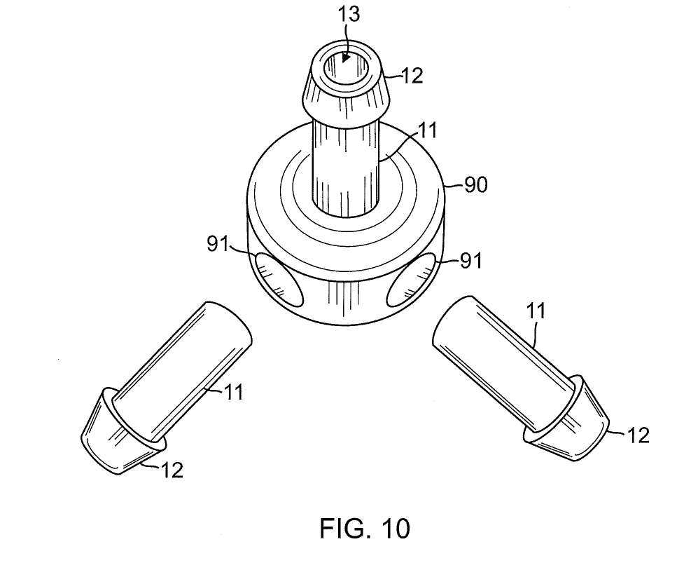

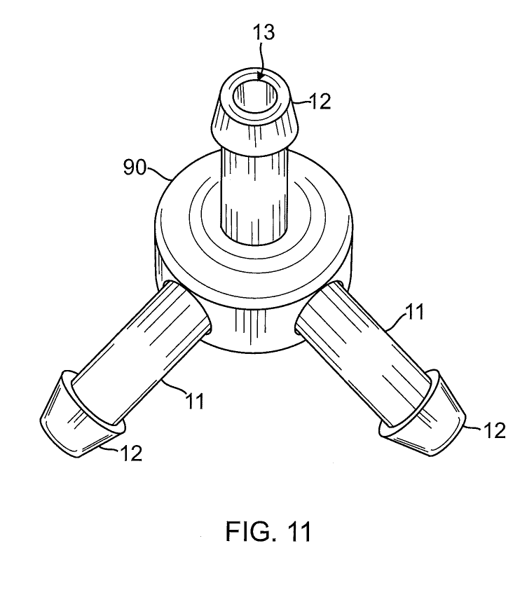

Referring now to FIGS. 9-11, an example of an embodiment can comprise a body 90 to which are attached a plurality of tubular portions 11. Each tubular portion 11 can have one or more barbs 12 formed thereon. The tubular portions 11 can have bores 13 formed therethrough such that the tubular portions are in acoustic communication with one another.

The body 90 can be generally cylindrical in configuration. One of the tubular portions 11 can extend from a generally flat surface of the body 90. For example, a tubular portion 11 configured for attachment to an earpiece or an ear insert can extend from the flat surface of the body 90. A tubular portion 11 can similarly extend from the opposite generally flat surface of the body 90, if desired.

One or more of the tubular portions 11 can extend from a curved portion of the body 90. For example, two tubular portions 11 that are configured for attachment to acoustic tubing can extend from the curved portion of the body 90.

The body 90 and the tubular portions 11 can be formed as an integral unit. For example, the body 90 and the tubular portions 11 can be integrally molded from plastic. As a further example, the body 90 and the tubular portions 11 can be machined from a single piece of metal.

Alternatively, the body 90 and the tubular portion 11 can be formed separately and subsequently attached together. The tubular portions 11 can be attached to the body by friction fit, adhesive bonding, threading, welding, or any other desired method.

The body 90 and the tubular portions 11 can be formed of stainless steel, aluminum, magnesium, plastic, or any other desire material. The body 90 and the tubular portions 11 can be formed of different materials. For example, the body 90 can be formed of aluminum and the tubular portions 11 can be formed of plastic.

The length of the tubular portions 11 of any embodiment can vary, as desired. For example, the length of the tubular portions can be between two and twenty millimeters, such as ten millimeters.

The inner and outer diameters of the tubular portions 11 of any embodiment can vary, as desired. For example, the inner diameter of the tubular portions 11 can be between one half millimeter and four millimeters, such as two millimeters. For example, the outer diameter of the tubular portions 11 can be between one millimeter and five millimeters, such as three millimeters.

Multiple audio devices, such as any desired combination of two-way radios, cellular telephones and music players, can be attached to an earpiece. In this manner, an earpiece can be used to simultaneously listen to a plurality of such audio devices. A user can listen to multiple audio devices without reconfiguring an earpiece that is used for such listening.

For example, a user can simultaneously listen to a two-way radio and a cellular telephone. As a further example, a user can simultaneously listen to a cellular telephone and a music player. The audio devices that are connected to the multiple input acoustic coupler do not have to be different audio devices. For example, a user can listen to two or more cellular telephones. Similarly, a user can listen to two or more two-way radios.

The multiple input acoustic coupler allows a user to attach and/or listen to multiple audio devices without having to reconfigure the system. This is particularly advantageous in police operations and battlefield situations, where it may not be safe to reconfigure the system.

The multiple input acoustic coupler can be configured so as to provide enhanced ergonomics and routing with respect to acoustic tubing. The acoustic tubing can be routed around the tragus in an ergonomic manner that mitigates undesirable contact with the tragus and/or other anatomical structures of the ear and thus enhance comfort and avoids abrasion.

The multiple input acoustic coupler can make operation of the audio device simpler. For example, a cellular telephone need not be raised to the ear in order to hear it. Again, this may be particularly advantageous in police operations and battlefield situations.

The multiple input acoustic coupler can be used in applications other than communications systems. For example, the multiple input acoustic coupler can be used to direct pressure signals and/or fluid flow in a variety of different tubing systems.

Embodiments described above illustrate, but do not limit, the invention. It should also be understood that numerous modifications and variations are possible in accordance with the principles of the present invention. Accordingly, the scope of the invention is defined only by the following claims.

1. An acoustic coupler comprising:
an output port configured to attach to an earpiece; and
a plurality of input ports in acoustic communication with the output port.

2. The acoustic coupler as recited in claim 1, wherein at least one port comprises at least one barb.

3. The acoustic coupler as recited in claim 1, wherein at least one port comprises one barb.

4. The acoustic coupler as recited in claim 1, wherein at least one port comprises two barbs.

5. The acoustic coupler as recited in claim 1, wherein at least one port comprises three barbs.

6. The acoustic coupler as recited in claim 1, wherein at least one port has no barbs.

7. The acoustic coupler as recited in claim 1, wherein the input ports are generally orthogonal with respect to the output port.

8. The acoustic coupler as recited in claim 1, wherein the input ports are not generally orthogonal with respect to the output port.

9. The acoustic coupler as recited in claim 1, wherein the output port and the input ports are generally orthogonal with respect to one another.

10. The acoustic coupler as recited in claim 1, wherein the output port and the input ports are not generally orthogonal with respect to one another.

11. The acoustic coupler as recited in claim 1, wherein the input ports are approximately the same size with respect to one another.

12. The acoustic coupler as recited in claim 1, wherein the output port and the input ports are approximately the same size with respect to one another.

13. The acoustic coupler as recited in claim 1, wherein all of the ports have approximately the same diameter.

14. The acoustic coupler as recited in claim 1, wherein all of the ports do not have approximately the same diameter.

15. The acoustic coupler as recited in claim 1, wherein all of the ports have approximately the same length.

16. The acoustic coupler as recited in claim 1, wherein all of the ports do not have approximately the same length.

17. The acoustic coupler as recited in claim 1, wherein the plurality of input ports comprises two input ports.

18. The acoustic coupler as recited in claim 1, wherein the plurality of input ports comprises three input ports.

19. The acoustic coupler as recited in claim 1, wherein the plurality of input ports comprises four input ports.

20. The acoustic coupler as recited in claim 1, wherein the input port and the output ports are formed of plastic.

21. The acoustic coupler as recited in claim 1, wherein the input ports and the output port are integrally formed.

22. An earpiece assembly comprising:
an earpiece configured to be received within the conchae of an ear;
an acoustic coupler attached to the earpiece, the acoustic coupler comprising:
an output port configured to attach to the earpiece; and
a plurality of input ports in acoustic communication with the output port.

23. A cable assembly comprising:
at least two electrical cables configured to communicate electrical signals representative of sound;
at least two speakers, each speaker in electrical communication with a dedicated one of the electrical cables;
at least two acoustic tubes, each acoustic tube in acoustic communication with a dedicated one of the speakers;
an acoustic coupler in acoustic communication with the acoustic tubes, the acoustic coupler comprising:
an output port configured to attach to an earpiece;
a plurality of input ports in acoustic communication with the output port, wherein the acoustic tubes are in acoustic communication with the acoustic coupler via the input ports; and
an earpiece in acoustic communication with multiple input acoustic couplers.

24. A method for assembling an earpiece assembly, the method comprising:
attaching an acoustic coupler to an earpiece;
wherein the acoustic coupler comprises:
an output port configured to attach to the earpiece; and
a plurality of input ports in acoustic communication with the output port.

25. An acoustic coupler comprising:
an output port; and
means for facilitating acoustic communication from a plurality of audio devices to the output port.

26. An acoustic coupler comprising:
a body;
a first barbed tubular portion attached to the body, the first barbed tubular portion having an output port; and
two second barbed tubular portions attached to the body, the two barbed second tubular portions each having an input port that is in acoustic communication with the output port.

27. The acoustic coupler as recited in claim 26, wherein the body, the first barbed tubular portion, and the two second barbed tubular portions comprise aluminum.

28. A method for providing sound from two audio devices to an earpiece, the method comprising acoustically mixing the sound in a fitting that is attached to the earpiece.
